(19) United States
(12) Patent Application Publication
(10) Pub. No.: US 2016/0073251 A1
(43) Pub. Date: Mar. 10, 2016

(54) Device of Handling Open Direct Discovery

(71) Applicant: HTC Corporation, Taoyuan City (TW)

(72) Inventor: Ching-Yu Liao, Taoyuan City (TW)

(21) Appl. No.: 14/849,585

(22) Filed: Sep. 9, 2015

Related U.S. Application Data
(60) Provisional application No. 62/048,285, filed on Sep. 10, 2014.

(51) Int. Cl. H04W 8/00; H04W 76/02

(52) U.S. Cl. CPC H04W 8/005; H04W 76/023; H04W 84/042

(57) ABSTRACT

A communication device for handling an open direct discovery comprises a storage unit for storing instructions and a processing means coupled to the storage unit. The processing means is configured to execute the instructions stored in the storage unit. The instructions comprise detecting a proximity service (ProSe) Application Code in a discovery message transmitted by an announcing user equipment (UE); and transmitting a discovery notification message to a ProSe function in a home public land mobile network (HPLMN) of the communication device, wherein the discovery notification message comprises a discovery notification for a ProSe Application ID corresponding to the ProSe Application Code.

### CROSS REFERENCE TO RELATED APPLICATIONS

This application claims the benefit of U.S. Provisional Application No. 62/048,285, filed on Sep. 10, 2014 and incorporated herein by reference.

### BACKGROUND OF THE INVENTION

1. Field of the Invention

The present invention relates to a communication device used in a wireless communication system, and more particularly, to a communication device of handling an open direct discovery in a wireless communication system.

2. Description of the Prior Art

A long-term evolution (LTE) system supporting the 3rd Generation Partnership Project (3GPP) Rel-8 standard and/or the 3GPP Rel-9 standard are developed by the 3GPP as a successor of the universal mobile telecommunication system (UMTS) for further enhancing performance of the UMTS to satisfy increasing needs of users. The LTE system includes a new radio interface and a new radio network architecture that provides high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple user equipments (UEs), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint (CoMP) transmissions/reception, uplink (UL) multiple-input multiple-output (UL-MIMO), etc. For a UE and an eNB to communicate with each other in the LTE-A system, the UE and the eNB must support standards developed for the LTE-A system, such as the 3GPP Rel-10 standard or later versions.

Device-to-device (D2D) communication may be realized, after an initialization (e.g., connection establishment and/or peer discovery) is performed (e.g., assisted by an eNB). Then, two UEs may communicate (e.g., transmitting and/or receiving packets) with each other directly according to the D2D communication, and the eNB does not need to forward the packets transmitted between the communication devices. According to the D2D communication, the UEs may communicate with each other via UL resources (e.g., UL subframes configured by the eNB). In general, the D2D communication may also be seen as a D2D service (i.e., proximity service (ProSe)). In addition, a D2D subframe, D2D transmission, D2D communication and D2D discovery can be termed as a sidelink subframe, sidelink transmission, sidelink communication and sidelink discovery, respectively.

An announcing UE can announce information which can be used by UEs in proximity if the UEs have permission for proximity discovery. A monitoring UE can monitor information of interest in proximity transmitted by announcing UEs. For the announcing UE, a ProSe Application Code can be received from a HPLMN ProSe function by performing an announce request procedure. The ProSe Application Code is included in a message which can be transmitted over a radio interface by a UE engaged in a ProSe direct discovery procedure to monitoring UEs. For the monitoring UE, Discovery Filter(s) for monitoring the ProSe Application Code(s) over the radio interface can be received from the HPLMN ProSe function when performing a monitor request procedure.

However, the announcing UE does not know whether a monitoring UE has detected a ProSe Application Code, after the announcing UE broadcasts the ProSe Application Code. There is not any procedure according to which the announce UE and/or the network can obtain information related to the detection of the ProSe Application Code. The ProSe may not be performed regularly or may be delayed, if the announcing UE cannot obtain the information of the detection.

Thus, how to handle an open direct discovery for the ProSe is an important problem to be solved.

### SUMMARY OF THE INVENTION

The present invention therefore provides a method and related communication device for handling an open direct discovery to solve the abovementioned problem.

A communication device for handling an open direct discovery comprises a storage unit for storing instructions and a processing means coupled to the storage unit. The processing means is configured to execute the instructions stored in the storage unit. The instructions comprise detecting a proximity service (ProSe) Application Code in a discovery message transmitted by an announcing user equipment (UE); and transmitting a discovery notification message to a ProSe function in a home public land mobile network (HPLMN) of the communication device, wherein the discovery notification message comprises a discovery notification for a ProSe Application ID corresponding to the ProSe Application Code. The ProSe Application ID is an identity used for ProSe Direct Discovery, for identifying application related information for the ProSe-enabled UE. Each ProSe Application ID could be globally unique. The ProSe Application Code is associated with the ProSe Application ID and used in the discovery procedures.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

### DETAILED DESCRIPTION

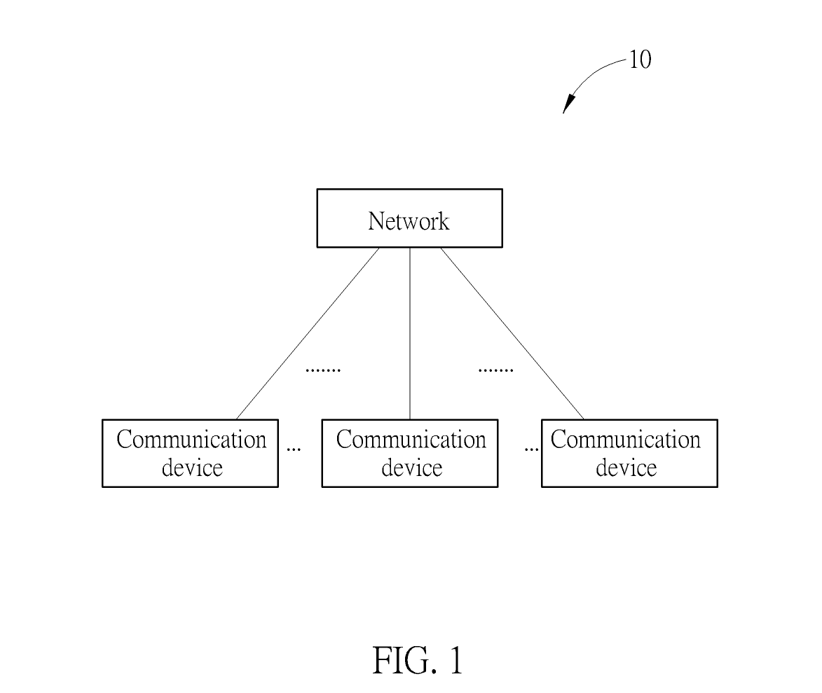

FIG. 1 is a schematic diagram of a wireless communication system 10 according to an example of the present invention. The wireless communication system 10 is briefly composed of a network and a plurality of communication devices. In FIG. 1, the network and the communication devices are simply utilized for illustrating the structure of the wireless communication system 10. A communication device may communicate with the network according to a device-to-cellular (D2C) communication defined in a communication standard, e.g., the 3rd Generation Partnership Project (3GPP) standard. Practically, the network can be a universal terrestrial radio access network (UTRAN) comprising at least one Node-B (NB) in a universal mobile telecommunications system (UMTS). In another example, the network can be an evolved UTRAN (E-UTRAN) comprising at least one evolved NB (eNB) and/or at least one relay in a long term evolution (LTE) system, a LTE-Advanced (LTE-A) system or an evolution of the LTE-A system.

Furthermore, the network may also include both the UTRAN/E-UTRAN and a core network (e.g., evolved packet core (EPC) network), wherein the core network may include network entities such as Mobility Management Entity (MME), Serving Gateway (S-GW), Packet Data Network (PDN) Gateway (P-GW), Self-Organizing Networks (SON) server and/or Radio Network Controller (RNC), etc. In other words, after the network receives information transmitted by a communication device, the information may be processed only by the UTRAN/E-UTRAN and decisions corresponding to the information are made at the UTRAN/E-UTRAN. Alternatively, the UTRAN/E-UTRAN may forward the information to the core network, and the decisions corresponding to the information are made at the core network after the core network processes the information. In addition, the information can be processed by both the UTRAN/E-UTRAN and the core network, and the decisions are made after coordination and/or cooperation are performed by the UTRAN/E-UTRAN and the core network.

A communication device maybe a user equipment (UE), a low cost device (e.g., machine type communication (MTC) device), a device-to-device (D2D) device, a mobile phone, a laptop, a tablet computer, an electronic book, a portable computer system, or combination thereof. In addition, for the D2C communication, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

In addition, two communication devices may communicate with each other directly, after an initialization (e.g., connection establishment and/or peer discovery) is performed. For example, the initialization may be assisted by the network. That is, the communication devices may communicate (e.g., transmit and/or receive packets) with each other according to a D2D communication (e.g., proximity service (ProSe)) defined in a communication standard, e.g., the 3GPP standard. The communication devices may communicate with each other via UL subframes determined according to frequency-division duplexing (FDD) configuration and/or time-division duplexing (TDD) configurations.

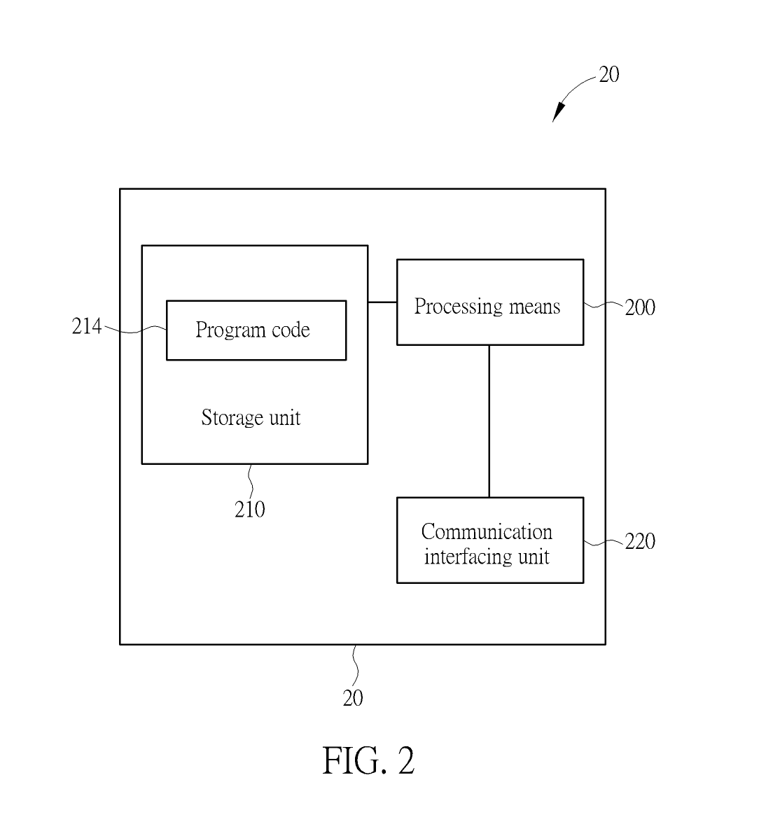

FIG. 2 is a schematic diagram of a communication device 20 according to an example of the present invention. The communication device 20 may be a communication device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage unit, non-transitory computer-readable medium (e.g., tangible media), etc. The communication interfacing unit 220 is preferably a transceiver and is used to transmit and receive signals (e.g., data, signals, messages and/or packets) according to processing results of the processing means 200.

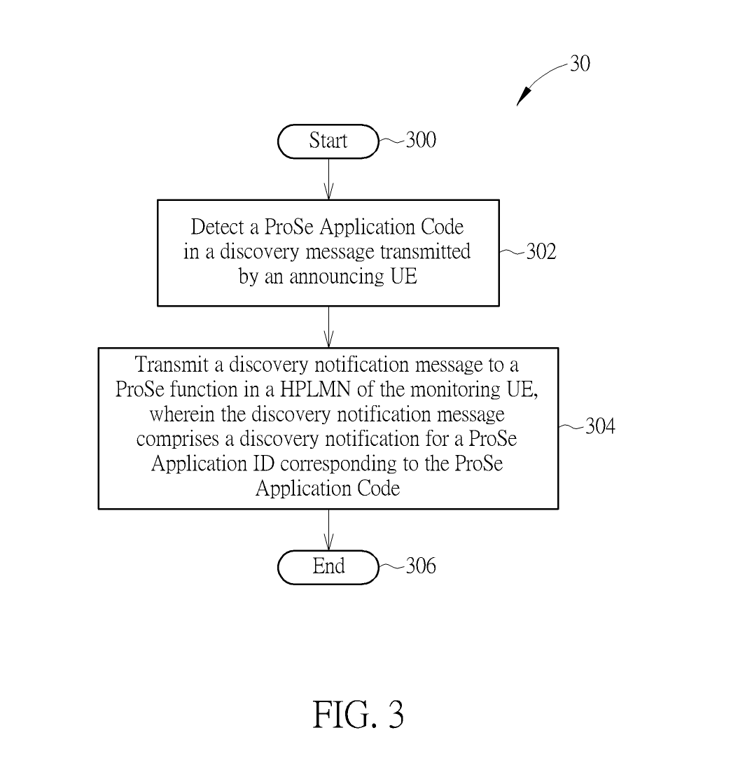

FIG. 3 is a flowchart of a process 30 according to an example of the present invention. The process 30 may be utilized in a monitoring UE (e.g., a communication device in FIG. 1), to handle an open direct discovery. The process 30 may be compiled into the program code 214 and includes the following steps:

Step 300: Start.

Step 302: Detect a ProSe Application Code in a discovery message transmitted by an announcing UE.

Step 304: Transmit a discovery notification message to a ProSe function in a home public land mobile network (HPLMN) of the monitoring UE, wherein the discovery notification message comprises a discovery notification for a ProSe Application ID corresponding to the ProSe Application Code.

Step 306: End.

According to the process 30, the monitoring UE detects a ProSe Application Code included in a discovery message transmitted by an announcing UE (e.g., another communication device in FIG. 1). Then, the monitoring UE transmits a discovery notification message to a ProSe function in a HPLMN of the monitoring UE, wherein the discovery notification message comprises a discovery notification for a ProSe Application ID corresponding to the ProSe Application Code. That is, the monitoring UE transmits the discovery notification message to notify the detection of the ProSe Application Code to the announcing UE, if there is a ProSe Application ID corresponding to the ProSe Application Code. Thus, the announcing UE and/or a ProSe function in a HPLMN of the announcing UE can know the detection of the ProSe Application Code from the monitoring UE. As a result, the ProSe between the announcing UE and the monitoring UE can be performed regularly.

Realization of the present invention is not limited to the above description. The following examples can be applied to the processes 30 and/or 40.

In one example, the discovery notification message in the process 30 may include the ProSe Application ID or the ProSe Application Code. The ProSe Application ID may be an identity used for ProSe Direct Discovery, identifying application related information for the ProSe-enabled UE. In one example, the discovery notification message may be a message followed by a match report message. The discovery notification message may be transmitted, if a correspondence between the ProSe Application ID and the ProSe Application Code is received in a match report response message or is indicated in a mapping table stored in the monitoring UE. In one example, the discovery notification message may include a UE identity of the monitoring UE. In one example, the discovery notification message may include application layer information for an application operated in the monitoring UE, wherein the application is ProSe-enabled and is associated with the ProSe Application ID. The application layer information may include an application ID or an application layer user ID. The application ID may be a globally unique identifier identifying the application. The application layer user ID may be an identity which identifies a user within the context of the application. In addition, the discovery notification message may include location information of another user for the ProSe Application ID of the monitoring UE.

In one example, the discovery notification message in the process 30 may be transmitted, if an indication of the discovery notification corresponding to the ProSe Application ID is stored in the monitoring UE. Further, the indication of the discovery notification may be stored in the monitoring UE along with the ProSe Application ID according to information included in a monitor response message received from the ProSe function in the HPLMN of the monitoring UE. In one example, the monitor response message may be in response to a monitor request message transmitted by the monitoring UE for requesting an authorization for the ProSe Application ID. In addition, the monitor response message may include the ProSe Application Code and/or a discovery filter (i.e., discovery mask) corresponding to the ProSe Application ID.

In one example, the indication of the discovery notification in a first monitor response message received by the monitoring UE may be obtained from a second monitor response message transmitted by a ProSe function in a HPLMN of the announcing UE, if the ProSe function in the HPLMN of the announcing UE stores the indication of the discovery notification with the ProSe Application ID. Further, the second monitor response message may be in response to a monitor request message transmitted by the ProSe function in the HPLMN of the monitoring UE after the ProSe Function in the HPLMN of the monitoring UE receives another monitor request message from the monitoring UE. In addition, the indication of the discovery notification may be stored by the ProSe function in the HPLMN of the announcing UE, if the ProSe function in the HPLMN of the announcing UE receives an announce request message transmitted by the announcing UE including the ProSe Application ID and the indication of the discovery notification.

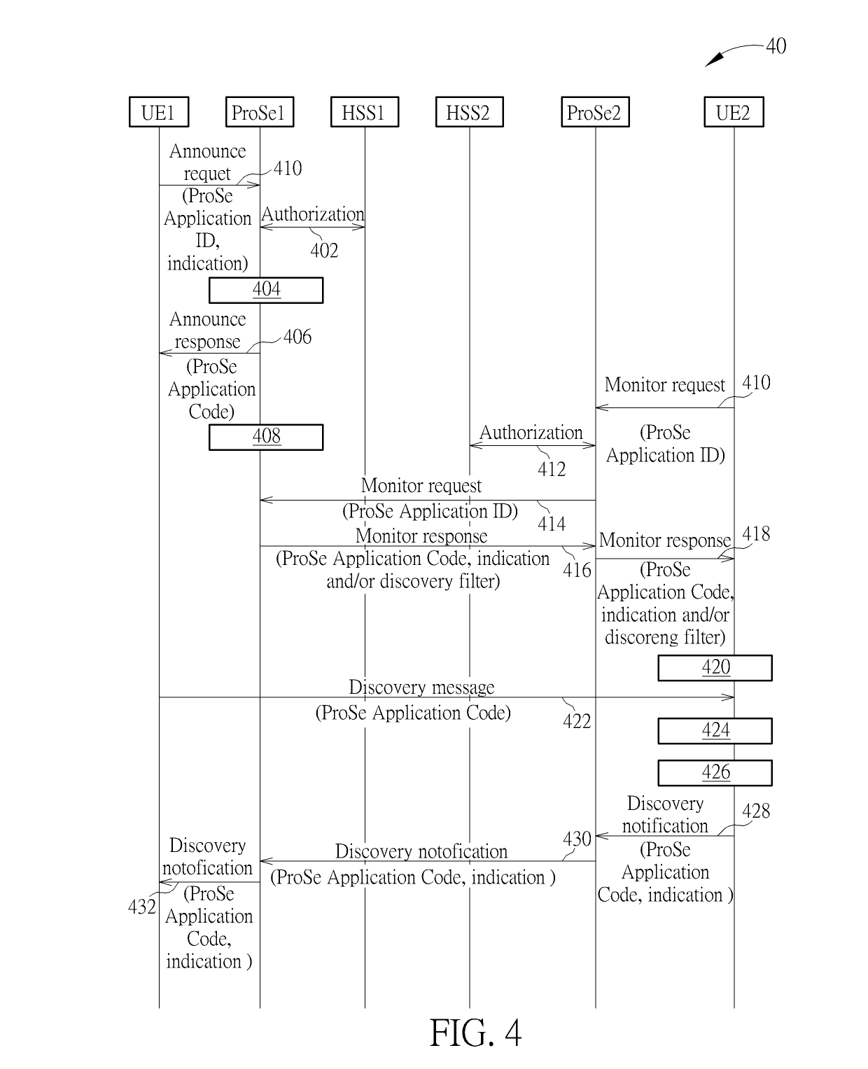

FIG. 4 is a flowchart of a process 40 according to an example of the present invention, where UEs UE1-UE2, ProSe functions ProSe1-ProSe2, and HSSs HSS1-HSS2 are shown. In the present example, the UE UE1 may be an announcing UE, and the UE UE2 may be a monitoring UE. The ProSe function ProSe1 may be a ProSe function of a HPLMN of the UE UE1, and the ProSe function ProSe2 may be a ProSe function of a HPLMN of the UE UE2.

Operation of the process 40 is described as follows. The UE UE1 may transmit an announce request message (e.g., including a ProSe Application ID and an indication) to the ProSe function ProSe1 to initiate a proximity discovery (step 400), wherein the indication may be used for a discovery notification. Accordingly, the ProSe function ProSe1 may perform an authorization procedure for the proximity discovery with the HSS HSS1 (step 402). The ProSe function ProSe1 may generate a ProSe Application Code according to the ProSe Application ID after performing the authorization procedure (step 404). Then, the ProSe function ProSe1 may transmit an announce response message (e.g., including the ProSe Application Code) to the UE UE1 (step 406), and may store the ProSe Application Code and the indication corresponding to the ProSe Application ID (step 408).

On the other hand, the UE UE2 may transmit a monitor request message (e.g., including the ProSe Application ID) to the ProSe function ProSe1 (step 410). Accordingly, the ProSe function ProSe2 may perform an authorization procedure for the proximity discovery with the HSS HSS2 (step 412). The ProSe function ProSe2 may transmit a monitor request message (e.g., including the ProSe Application ID) to the ProSe function ProSe1 after performing the authorization procedure (step 414). Then, the ProSe function ProSe1 may transmit a monitor response message (e.g., including the ProSe Application Code, the indication and/or a discovery filter) to the ProSe function ProSe2 in response to the reception of the monitor request message (step 416). The monitor response message may be forwarded from the ProSe function ProSe2 to the UE UE2 (step 418). The UE UE2 may store the ProSe Application Code, the indication and/or the discovery filter after receiving the monitor response message (step 420).

According to the present invention, the UE UE2 may detect the ProSe Application Code in a discovery message transmitted by the UE UE1. Then, the UE UE2 may check the correspondence between the ProSe Application Code and the ProSe Application ID (step 424), e.g., according to a mapping table stored in the UE UE2. The UE UE2 may further check the indication of the discovery notification (step 426). The UE UE2 may transmit a discovery notification message (e.g., including the ProSe Application Code and information) to the ProSe function ProSe2 (step 428). Content of the information can be referred to the previous description related to discovery notification message, and is not narrated herein. The discovery notification message is then forwarded from the ProSe function ProSe2 to the ProSe function ProSe1 (step 430), and is further forwarded from the ProSe function ProSe1 to the UE UE1 (step 432). Thus, the UE UE1 can be aware of the detection of the ProSe Application Code.

It should be noted that although the examples are illustrated based on the process 30 and/or 40, to clarify the operations of the announcing UE, the monitoring UE, the ProSe functions, and the HSSs. The examples can be combined and/or modified arbitrarily according to system requirements and/or design considerations.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means maybe the communication device 20.

Examples of the hardware may include analog circuit(s), digital circuit(s) and/or mixed circuit(s). For example, the hardware may include ASIC(s), field programmable gate array(s) (FPGA(s)), programmable logic device(s), coupled hardware components or combination thereof. In another example, the hardware may include general-purpose processor(s), microprocessor(s), controller(s), digital signal processor(s) (DSP(s)) or combination thereof.

Examples of the software may include set(s) of codes, set(s) of instructions and/or set(s) of functions retained (e.g., stored) in a storage unit, e.g., a computer-readable medium. The computer-readable medium may include SIM, ROM, flash memory, RAM, CD-ROM/DVD-ROM/BD-ROM, magnetic tape, hard disk, optical data storage device, non-volatile storage unit, or combination thereof. The computer-readable medium (e.g., storage unit) may be coupled to at least one processor internally (e.g., integrated) or externally (e.g., separated). The at least one processor which may include one or more modules may (e.g., be configured to) execute the software in the computer-readable medium. The set(s) of codes, the set(s) of instructions and/or the set(s) of functions may cause the at least one processor, the module(s), the hardware and/or the electronic system to perform the related steps.

Examples of the electronic system may include a system on chip (SoC), system in package (SiP), a computer on module (CoM), a computer program product, an apparatus, a mobile phone, a laptop, a tablet computer, an electronic book or a portable computer system, and the communication device 20.

To sum up, the present invention provides a method and related communication device for handling an open direct discovery. An announcing UE and/or a ProSe function in a HPLMN of the announcing UE can know whether a ProSe Application Code is detected by a monitoring UE. As a result, the ProSe between the announcing UE and the monitoring UE can be performed regularly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling an open direct discovery, comprising:
a storage unit for storing instructions of:
detecting a proximity service (ProSe) Application Code in a discovery message transmitted by an announcing user equipment (UE); and
transmitting a discovery notification message to a ProSe function in a home public land mobile network (HPLMN) of the communication device, wherein the discovery notification message comprises a discovery notification for a ProSe Application ID corresponding to the ProSe Application Code; and
a processing means, coupled to the storage unit, configured to execute the instructions stored in the storage unit.

2. The communication device of claim 1, wherein the discovery notification message comprises the ProSe Application ID or the ProSe Application Code.

3. The communication device of claim 1, wherein the discovery notification message is transmitted, if a correspondence between the ProSe Application ID and the ProSe Application Code is received in a match report response message or is indicated in a mapping table stored in the communication device.

4. The communication device of claim 1, wherein the discovery notification message comprises a UE identity of the communication device.

5. The communication device of claim 1, wherein the discovery notification message comprises application layer information for an application operated in the communication device, wherein the application is ProSe-enabled and is associated with the ProSe Application ID.

6. The communication device of claim 1, wherein the discovery notification message is transmitted, if an indication of the discovery notification corresponding to the ProSe Application ID is stored in the communication device.

7. The communication device of claim 6, wherein the indication of the discovery notification is stored in the communication device along with the ProSe Application ID according to information comprised in a monitor response message received from the ProSe function in the HPLMN of the communication device.

8. The communication device of claim 7, wherein the monitor response message is in response to a monitor request message transmitted by the communication device for requesting an authorization for the ProSe Application ID.

9. The communication device of claim 8, wherein the monitor response message comprises the ProSe Application Code and/or a discovery filter corresponding to the ProSe Application ID.

10. The communication device of claim 6, wherein the indication of the discovery notification in a first monitor response message received by the communication device is obtained from a second monitor response message transmitted by a ProSe function in a HPLMN of the announcing UE, if the ProSe function in the HPLMN of the announcing UE stores the indication of the discovery notification with the ProSe Application ID.

11. The communication device of claim 10, wherein the second monitor response message is in response to a monitor request message transmitted by the ProSe function in the HPLMN of the communication device after the ProSe Function in the HPLMN of the communication device receives another monitor request message from the communication device.

12. The communication device of claim 10, wherein the indication of the discovery notification is stored by the ProSe function in the HPLMN of the announcing UE, if the ProSe function in the HPLMN of the announcing UE receives an announce request message transmitted by the announcing UE comprising the ProSe Application ID and the indication of the discovery notification.
